(19) United States
(12) Patent Application Publication
(10) Pub. No.: US 2015/0100340 A1
(43) Pub. Date: Apr. 9, 2015

(54) SYSTEMS AND METHODS FOR HOSPITAL ENERGY MANAGEMENT

(71) Applicant: Allen Technologies, Inc., Austin, TX (US)

(72) Inventors: Jerry Folsom, The Hills, TX (US); Derek Forman, Forestvilla, CA (US); Deepti Busireddy, Austin, TX (US); Brian Smith, Austin, TX (US)

(21) Appl. No.: 14/506,211

(22) Filed: Oct. 3, 2014

Related U.S. Application Data
(60) Provisional application No. 61/887,254, filed on Oct. 4, 2013.

(51) Int. Cl. G05B 15/02; F24F 11/00; G06F 19/00; G06Q 10/00; G06Q 50/22

(52) U.S. Cl. CPC G05B 15/02; G06Q 10/20; G06Q 50/22; G06F 19/3412; F24F 11/0009
USPC 705/2; 700/90; 700/276

(57) ABSTRACT

A computer-implemented method for hospital energy management is described. Admission discharge transfer (ADT) information is received from a hospital ADT system. At least a portion of the ADT information received from the hospital ADT system is analyzed. A control signal is generated based on the analysis of the ADT information. The control signal may include control information configured to control an aspect of equipment in the hospital.

This application claims priority to U.S. Provisional Patent Application Ser. No. 61/887,254 filed on Oct. 4, 2013 and entitled “System and Methods for Hospital Energy Management.” U.S. Provisional Patent Application Ser. No. 61/887,254 is herein incorporated by reference for all that is discloses.

### BACKGROUND

The use of computer systems and computer-related technologies continues to increase at a rapid pace. This increased use of computer systems has influenced the advances made to computer-related technologies. Indeed, computer systems have increasingly become an integral part of the business world and the activities of individual consumers. Computer systems may be used to carry out several business, industry, and academic endeavors. The wide-spread use of computers has been accelerated by the increased use of computer networks, including the Internet.

Many businesses use one or more computer networks to communicate and share data between the various computers connected to the networks. The productivity and efficiency of employees often require human and computer interaction. Users of computer technologies continue to demand an increase in the efficiency of these technologies. Improving the efficiency of computer technologies is always desirable to anyone who uses and relies on computers.

The wide-spread use of computing devices has seen an increased use of computer systems in hospital settings. Hospitals may use computing devices with many different types of systems such as hospital equipment, entertainment systems in patient rooms and waiting areas, lighting, heating and cooling, etc. As a result, benefits may be realized by implementing systems and methods for improving the efficiency of energy consumption by hospital equipment.

### SUMMARY

In a specific embodiment, a security system or home automation system may be used in conjunction with a power production system. A security system that may be used in conjunction with a power production system may comprise a security system for a home or other building at which equipment for generating solar power is used. An automation system that is useful with the power production system may comprise a system that automates the premises (e.g. building, a building space, etc.) with which the solar power generation equipment is used. The power production system may include a power production source comprising one or more solar panels, one or more of the solar panels being coupled to one or more inverters, wherein the power production source is configured to supply power to an electrical system. The combination of a security system or an automation system with a power production system may be referred to herein as a “premises control and power production system.” The premises control and power production system may further include a gateway unit in communication with the power production source and configured to obtain information regarding power production by the power production source. The premises control and power production system may further include a security system comprising a plurality of peripheral devices (e.g., security sensors, etc.) that can communicate with a control unit of the security system and the gateway unit, or an automation system comprising a plurality of peripheral devices (e.g., controlled devices, sensors, etc.), a control unit with which the peripheral devices of the automation system are configured to communicate and the gateway unit, the control unit of either type of system being configured to display a status of the security system and information regarding power production by the power production source.

According to at least one embodiment, a computer-implemented method for hospital energy management is described. In one embodiment, admission discharge transfer (ADT) information may be received from a hospital ADT system. At least a portion of the ADT information received from the hospital ADT system may be analyzed. A control signal may be generated based on the analysis of the ADT information. The control signal may include control information configured to control an aspect of equipment in the hospital.

In one embodiment, an encrypted connection may be established with the hospital ADT system. The encrypted connection established with the hospital ADT system may include a virtual private network (VPN) connection. The control signal may be generated based at least in part on a predetermined discharge time contained in the ADT information. In some cases, the hospital may be identified via the ADT information and the control signal may be generated based at least in part on the identified hospital. Additionally, or alternatively, an average discharge time may be calculated based on the ADT information received and the control signal may be generated based at least in part on the calculated average discharge time. ADT data stored in a database of the hospital ADT system may be updated based on the calculated average discharge time.

In one embodiment, the generated control information may include an occupancy control signal indicating occupancy of a room in the hospital. In some cases, the control information may be configured to perform an equipment check on equipment at the hospital. Upon determining a problem exists with equipment at the hospital based on the equipment check, a notification may be generated. Additionally, or alternatively, the control information may be configured to control at the hospital a heating ventilation air conditioning (HVAC) system, a lighting system, a media entertainment system, medical equipment, window coverings, and/or an appliance or other similar device located at the hospital.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating one example of an energy management module;

FIG. 3 is a flow diagram illustrating one embodiment of a method for hospital energy management;

FIG. 4 is a flow diagram illustrating one embodiment of a method for hospital energy management based on location; and

FIG. 5 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Referring in general to the accompanying drawings, various embodiments of the present invention are illustrated to show the structure and methods for monitoring or controlling local power generation or monitoring or controlling interaction of a local power system with a public utility grid. Common elements of the illustrated embodiments are designated with like numerals. It should be understood that the figures presented are not meant to be illustrative of actual views of any particular portion of the actual device structure, but are merely schematic representations which are employed to more clearly and fully depict embodiments of the invention.

The information technology (IT) system of a hospital may use admission discharge transfer (ADT) information to maintain an integrated patient management system designed to handle the entire patient care workflow, from the registration of patient information to bed tracking and discharge. The system may be configured to manage administration procedures for both inpatient and outpatient visits including allocating physicians, applying policies, and assigning beds. ADT information may be configured to deliver occupancy statistics and quality information regarding admissions, transfers and discharges. The systems and methods described herein relate to hospital energy management implemented to improve the efficiency and energy use of equipment in a hospital setting. Specifically, the systems and methods described herein leverage ADT information to manage energy use in a hospital setting resulting in improved efficiency and energy use of equipment located in and/or associated with the hospital.

It is time consuming for hospital staff to go through a checklist of equipment and items to check when a patient is admitted, discharged, and/or transferred. As a result, benefits may be realized by implementing systems and methods to dynamically modify energy use to adapt to changing conditions automatically in hospital settings.

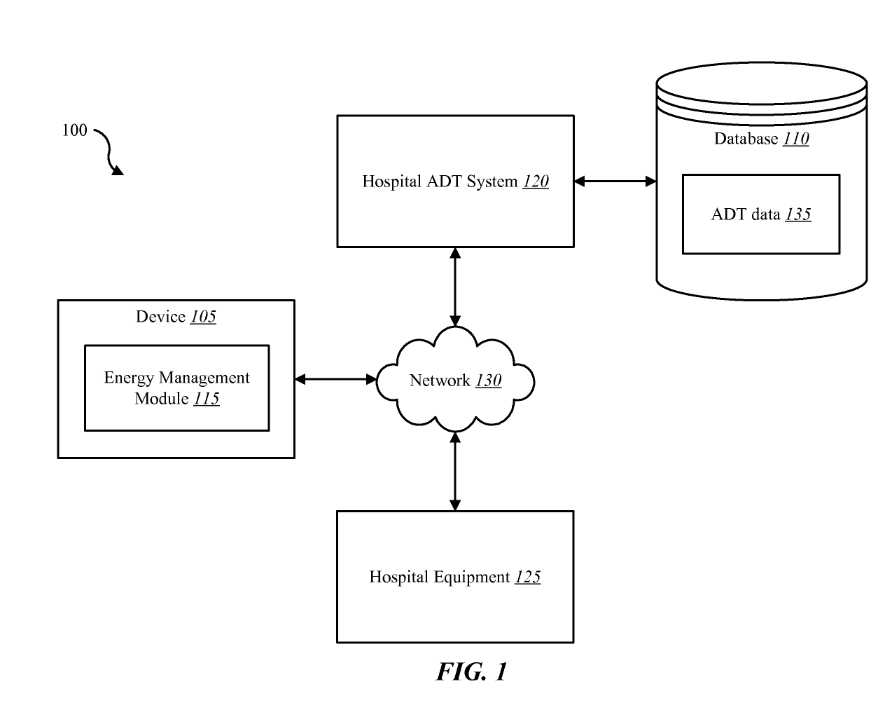

FIG. 1 is a block diagram illustrating one embodiment of an environment 100 in which the present systems and methods may be implemented. As depicted, environment 100 may include device 105, network 130, hospital ADT system 120, and hospital equipment 125. In some embodiments, the systems and methods described herein may be performed on a single device (e.g., device 105). Examples of devices 105 include mobile devices, smart phones, tablets, laptops, personal computing devices, dedicated-use computers, servers, etc.

In some embodiments, device 105 may communicate with hospital ADT system 120, hospital equipment 125, and/or database 110 via network 130. Example of networks 130 include, local area networks (LAN), wide area networks (WAN), virtual private networks (VPN), wireless networks (using 802.11, for example), cellular networks (using 3G and/or LTE, for example), etc. It is noted that in some embodiments, the device 105 may not include an energy management module 115. In some embodiments, the device 105 may be located on-site at the hospital. In some cases, device 105 may be located off-site from the hospital. Additionally, or alternatively, one device may be located off-site from the hospital and another device may be located on-site at the hospital, and both on-site and off-site device may each include an energy management module 115 where at least a portion of the functions of the energy management module 115 are performed separately and/or concurrently on both the on-site device and the off-site device. In some cases, the hospital ADT system 120 may include the energy management module 115.

In some embodiments, the hospital ADT system 120 may be coupled to the database 110. For example, the energy management module 115 may access (e.g., read, write, update) ADT data 135 in the database 110 via the hospital ADT system 120. The database 110 may be internal or external to hospital ADT system 120. In one example, device 105 may be coupled to a database, such as database 110. In one embodiment, the database 110 may be internal to device 105. In another embodiment, the database 110 may be external to the device 105. In some cases, database 110 may be connected to hospital ADT system 120 as depicted in environment 100, and energy management module 115 may maintain a synchronized copy of the content of database 110 on device 105 or local to the location of device 105.

In some configurations, device 105 may include an energy management module 115. In some cases, in order to protect data transmitted to and from device 105, energy management module 115 may establish a secure connection with the hospital ADT system 120, database 110, and/or hospital equipment 125. In some cases, energy management module 115 may encrypt all data communications with hospital ADT system 120, database 110, and/or hospital equipment 125.

In some cases, energy management module 115 may establish a VPN connection between hospital ADT system 120, database 110, and/or hospital equipment 125. Establishing the VPN connection may include authentication and encryption algorithms. Thus, a device 105 may connect to hospital ADT system 120, database 110, and/or hospital equipment 125 through a VPN head-end via a VPN system. Additionally, the network 130 may feature gateways, nodes, and other network devices. For example, the network 130 may include a VPN head-end (VPNHE), a firewall with VPN, VPN gateway, or other similar security devices to securely connect device 105 to hospital ADT system 120, database 110, and/or hospital equipment 125. In some embodiments, the network 130 may be configured to issue security policies to determine VPN parameters such as encryption and authentication algorithms. In one embodiment, a data port may be associated with the VPN connection. At least a portion of data may be transmitted via the associated data port. A data packet received from the associated data port may be identified as data sent between device 105 and the hospital ADT system 120, database 110, and/or hospital equipment 125. A network policy may be enforced. The network policy may define a condition upon which device 105 is permitted to communicate with the hospital ADT system 120, database 110, and/or hospital equipment 125 over the VPN. The device 105 may be authenticated by sending a device identifier (e.g., media access control (MAC) address, device serial number, etc.) associated with the device 105. Additionally, a user of device 105 may be authenticated by requiring the user to enter credentials (e.g., user name, password, biometrics, etc.). In some cases, a VPN tunnel may be established by a component of an operating system on device 105, one or more applications running on device 105, or a combination of the two. Above the VPN in the network stack, the one or more applications may establish a connection with the hospital ADT system 120, database 110, and/or hospital equipment 125 (e.g., HTTP and/or secure hypertext transfer protocol (HTTPS)). The network communication protocol may be established in association with a certificate issued to the device 105. The energy management module 115 may be configured to allow data that complies with the network communication protocol to be sent over the VPN. A hospital ADT system 120 may interpret data that complies with the network communication protocol as data sent to or from device 105.

In one embodiment, the hospital ADT and HVAC systems 120 and 125 may each include an interface that allows the device 105, in conjunction with energy management module 115, to query, send data to, receive data from, and control one or more aspect of the hospital ADT system 120, database 110, and/or hospital equipment 125. Further details regarding the energy management module 115 are discussed below.

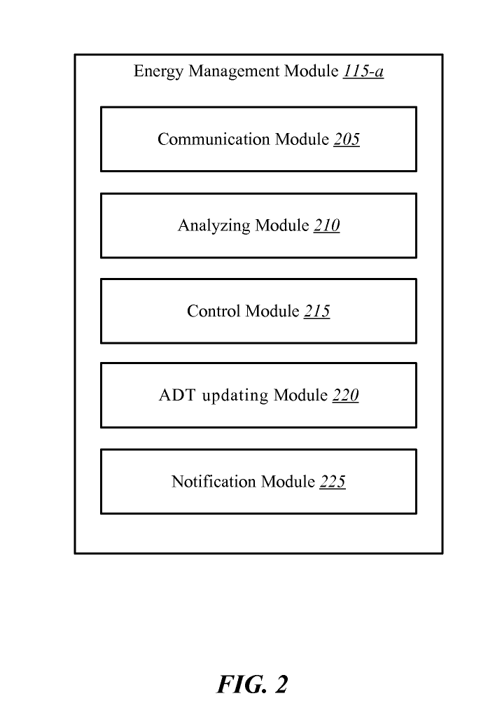

FIG. 2 is a block diagram illustrating one example of an energy management module 115-a. The energy management module 115-a may be one example of the energy management module 115 depicted in FIG. 1. As depicted, the energy management module 115-a may include a communication module 205, an analyzing module 210, a control module 215, an ADT updating module 220, and a notification module 225.

The energy management module 115-a may be configured to improve the efficiency and energy use of equipment in a hospital setting by interfacing with both the ADT system of the hospital and one or more pieces of energy consuming equipment associated with the hospital, resulting in a scalable solution that reduces electricity costs and increases energy conservation, and that is Health Insurance Portability and Accountability Act (HIPAA) compliant.

In one embodiment, communication module 205 may receive admission discharge transfer (ADT) information from a hospital ADT system. In some embodiments, communication module 205 may establish an encrypted connection with the hospital ADT system. In some cases, the encrypted connection established with the hospital ADT system may include a virtual private network (VPN) connection. Analyzing module may 210 analyze at least a portion of the ADT information received from the hospital ADT system. In some embodiments, control module may 215 generate a control signal based on the analysis of the ADT information, wherein the control signal may include control information configured to control an aspect of equipment in the hospital. In some cases, the control information may include an occupancy control signal indicating occupancy of a room in the hospital. Based on the occupancy control signal, equipment at the hospital may be powered off, powered on, placed in a standby mode, etc.

In one embodiment, control module 215 may generate the control signal based at least in part on a predetermined discharge time contained in the ADT information. In some cases, a hospital may establish a time period with a discharge time. After the lapse of the predetermined time a control signal is to be received in relation to equipment associated with the hospital. For example, a hospital may establish a time period of 45 minutes to be associated with discharge times. If the patient is discharged at 3:00 P.M., then the control signal is to be sent to the hospital 45 minutes after discharge, or at 3:45 P.M. Upon receiving the control signal, an aspect of equipment at the hospital may be controlled via the control signal. For example, certain equipment may be turned off, some equipment may be turned on, some equipment may be placed in a standby state, some equipment may be adjusted (e.g., temperature of a thermostat may be increased or decreased, window coverings closed or opened, etc.).

In one embodiment, analyzing module 210 may identify the hospital via the ADT information. In some cases, control module 215 may generate the control signal based at least in part on the identified hospital. In some embodiments, ADT updating module 220 may calculate an average discharge time based on the ADT information received. ADT updating module 220 may update ADT data stored in a database of the hospital ADT system based on the calculated average discharge time. In some cases, control module 215 may generate the control signal based at least in part on the calculated average discharge time. The control information may be configured to perform an equipment check on equipment at the hospital. Upon determining a problem exists with equipment at the hospital based on the equipment check, notification module 225 may generate a notification. In one or more embodiments, control information may be configured to control a heating ventilation air conditioning (HVAC) system at the hospital, control a lighting system at the hospital, control a media entertainment system at the hospital, control medical equipment at the hospital, control window coverings at the hospital, and/or control an appliance at the hospital. Medical equipment, which may be referred to as armamentarium, may include any equipment designed to aid in the diagnosis, monitoring or treatment of medical conditions.

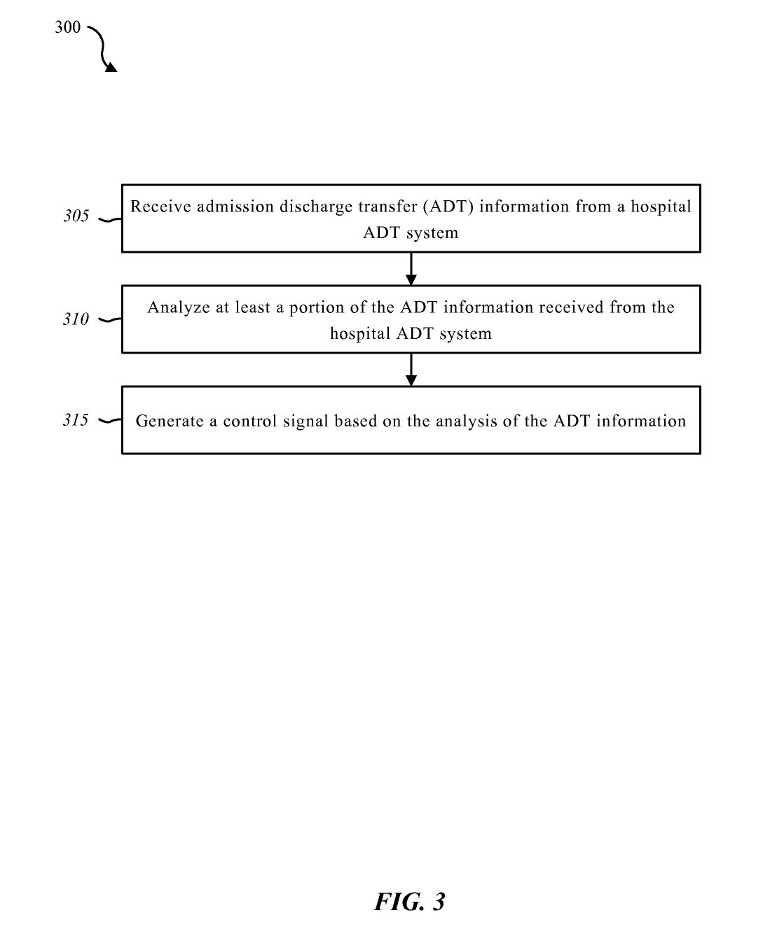

FIG. 3 is a flow diagram illustrating one embodiment of a method 300 for hospital energy management. In some configurations, the method 300 may be implemented by the energy management module 115 illustrated in FIGS. 1 and/or 2.

At block 305, admission discharge transfer (ADT) information may be received from a hospital ADT system. At block 310, at least a portion of the ADT information received from the hospital ADT system may be analyzed. At block 315, a control signal based on the analysis of the ADT information may be generated. The control signal may include control information configured to control an aspect of equipment in the hospital.

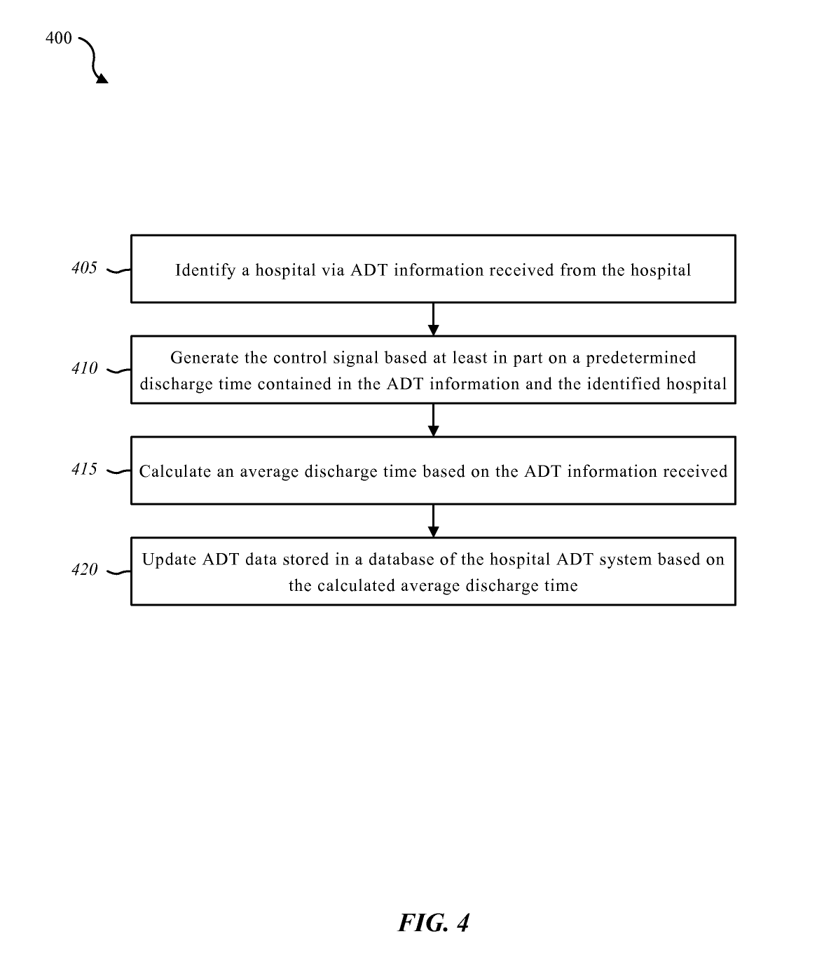

FIG. 4 is a flow diagram illustrating one embodiment of a method 400 for hospital energy management. In some configurations, the method 400 may be implemented by the energy management module 115 illustrated in FIGS. 1 and/or 2.

At block 405, may be identified a hospital via ADT information received from the hospital. At block 410, may be generated the control signal based at least in part on a predetermined discharge time contained in the ADT information and the identified hospital. At block 415, may be calculated an average discharge time based on the ADT information received. At block 420, may be updated ADT data stored in a database of the hospital ADT system based on the calculated average discharge time.

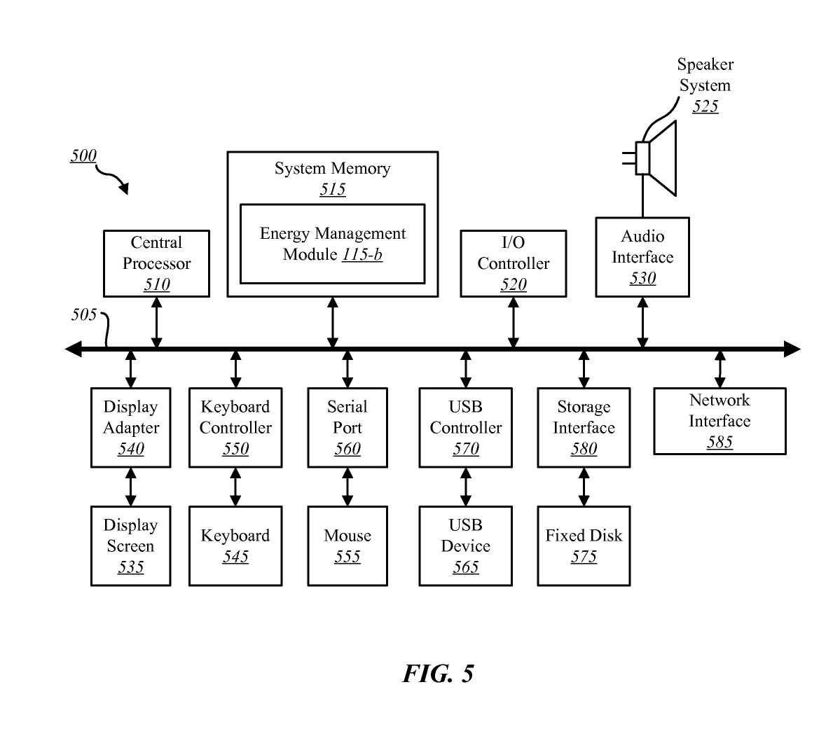

FIG. 5 depicts a block diagram of a computer system 500 suitable for implementing the present systems and methods. Computer system 500 includes a bus 505 which interconnects major subsystems of computer system 500, such as a central processor 510, a system memory 515 (typically RAM, but which may also include ROM, flash RAM, or the like), an input/output controller 520, an external audio device, such as a speaker system 525 via an audio output interface 530, an external device, such as a display screen 535 via display adapter 540, a keyboard 545 (interfaced with a keyboard controller 550) (or other input device), multiple USB devices 565 (interfaced with a USB controller 570), and a storage interface 580. Also included are a mouse 555 (or other point-and-click device) connected to bus 505 through serial port 560 and a network interface 585 (coupled directly to bus 505).

Bus 505 allows data communication between central processor 510 and system memory 515, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the energy management module 115-b to implement the present systems and methods may be stored within the system memory 515. Applications resident with computer system 500 are generally stored on and accessed via a non-transitory computer readable medium, such as a hard disk drive (e.g., fixed disk 575) or other storage medium. Additionally, applications can be in the form of electronic signals modulated in accordance with the application and data communication technology when accessed via interface 585.

Storage interface 580, as with the other storage interfaces of computer system 500, can connect to a standard computer readable medium for storage and/or retrieval of information, such as a fixed disk drive 575. Fixed disk drive 575 may be a part of computer system 500 or may be separate and accessed through other interface systems. Network interface 585 may provide a direct connection to a remote server via a direct network link to the Internet via a POP (point of presence). Network interface 585 may provide such connection using wireless techniques, including digital cellular telephone connection, Cellular Digital Packet Data (CDPD) connection, digital satellite data connection, or the like.

Many other devices or subsystems (not shown) may be connected in a similar manner (e.g., document scanners, digital cameras, and so on). Conversely, all of the devices shown in FIG. 5 need not be present to practice the present systems and methods. The devices and subsystems can be interconnected in different ways from that shown in FIG. 5. The operation of a computer system such as that shown in FIG. 5 is readily known in the art and is not discussed in detail in this application. Code to implement the present disclosure can be stored in a non-transitory computer readable medium such as one or more of system memory 515 or fixed disk 575. The operating system provided on computer system 500 may be iOS®, MS-DOS®, MSWINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method for energy management of a hospital, the method comprising:
receiving admission discharge transfer (ADT) information from a hospital ADT system;
analyzing at least a portion of the ADT information received from the hospital ADT system; and
generating a control signal based on the analysis of the ADT information, wherein the control signal comprises control information configured to control an aspect of equipment in the hospital.

2. The method of claim 1, further comprising:
establishing an encrypted connection with the hospital ADT system.

3. The method of claim 2, wherein the encrypted connection established with the hospital ADT system comprises a virtual private network (VPN) connection.

4. The method of claim 1, further comprising:
generating the control signal based at least in part on a predetermined discharge time contained in the ADT information.

5. The method of claim 1, further comprising:
identifying the hospital via the ADT information; and generating the control signal based at least in part on the identified hospital.

6. The method of claim 1, further comprising:
calculating an average discharge time based on the ADT information received;
updating ADT data stored in a database of the hospital ADT system based on the calculated average discharge time; and
generating the control signal based at least in part on the calculated average discharge time.

7. The method of claim 1, wherein the control information comprises an occupancy control signal indicating occupancy of a room in the hospital.

8. The method of claim 1, wherein the control information is configured to perform an equipment check on equipment at the hospital.

9. The method of claim 8, further comprising:
upon determining a problem exists with the equipment at the hospital based on the equipment check, generating a notification.

10. The method of claim 1, wherein the control information is configured to control a heating ventilation air conditioning (HVAC) system at the hospital.

11. The method of claim 1, wherein the control information is configured to control a lighting system at the hospital.

12. The method of claim 1, wherein the control information is configured to control a media entertainment system at the hospital.

13. The method of claim 1, wherein the control information is configured to control medical equipment at the hospital.

14. The method of claim 1, wherein the control information is configured to control window coverings at the hospital.

15. The method of claim 1, wherein the control information is configured to control an appliance at the hospital.

16. A system for energy management of a hospital, comprising;
a communication module to receive admission discharge transfer (ADT) information from a hospital ADT system;
an analyzing module to analyze at least a portion of the ADT information received from the hospital ADT system; and
control module to generate a control signal based on the analysis of the ADT information, wherein the control signal comprises control information configured to control an aspect of equipment in the hospital.

17. The system of claim 16, further comprising:
an ADT updating module to update ADT data stored in a database of the hospital ADT system based on a calculated average discharge time.

18. The system of claim 16, further comprising:
a notification module to generate a notification in response to determining a problem exists with equipment at the hospital.

19. The system of claim 16, wherein the control information comprises an occupancy control signal indicating occupancy of a room in the hospital.

20. The system of claim 16, wherein the control information is configured to perform an equipment check on equipment at the hospital.
